(19) United States
(12) Patent Application Publication
(10) Pub. No.: US 2018/0065857 A1
(43) Pub. Date: Mar. 8, 2018

(54) FORMATION OF BORON CARBIDE NANOPARTICLES FROM A BORON ALKOXIDE AND A POLYVINYL ALCOHOL

(71) Applicant: COMMISSARIAT A L'ENERGIE ATOMIQUE ET AUX ENERGIES ALTERNATIVES, Paris (FR)

(72) Inventors: Olivier Poncelet, Grenoble (FR); Pascal Fugier, Bernin (FR); Jonathan Skrzypski, Gurgy (FR)

(21) Appl. No.: 15/692,870

(22) Filed: Aug. 31, 2017

(30) Foreign Application Priority Data
Sep. 2, 2016 (FR) 16 58172

(51) Int. Cl. C01B 32/991; B01J 13/00; G21F 1/06

(52) U.S. Cl. CPC C01B 32/991; C01P 2004/64; G21F 1/06; B01J 13/0065

(57) ABSTRACT

The present invention relates to a process for the preparation of boron carbide nanoparticles, characterized in that it comprises at least the stages consisting in:
(i) interacting boric acid, boron oxide B₂O₃ or a boric acid ester of B(OR)₃ type, with R, which are identical or different, representing C₁₋₄-alkyl groups, with 1 to 2 molar equivalents of at least one C₂ to C₄ polyol, under conditions favorable to the formation of a boron alkoxide powder;
(ii) interacting, in an aqueous medium, the boron alkoxide powder obtained on conclusion of stage (i) with an effective amount of one or more completely hydrolyzed polyvinyl alcohols, with a molar mass of between 10 000 and 80 000 g.mol⁻¹, under conditions favorable to the formation of a crosslinked PVA gel, and
(iii) carrying out an oxidizing pyrolysis of the crosslinked gel formed on conclusion of the preceding stage (ii), under conditions favorable to the formation of the CB₄ nanoparticles.

This application is based upon and claims the benefit of priority of the prior French Patent Application No. 1658172, filed on Sep. 2, 2016, the entire contents of which are incorporated herein by reference.

The present invention relates to a novel process for the synthesis of boron carbide. It is very particularly advantageous from the viewpoint of the use of boron carbide as neutron absorber.

Both in radioprotection and in order to regulate the running of reactors, it is necessary to be able to absorb or reduce the neutron flux. The most advantageous atom, both as regards neutron absorption properties and in terms of abundance and low toxicity, is boron. Unfortunately, elemental boron is difficult to use because of its high reactivity.

Thus, up to now, the use of alternative materials which have a high percentage by weight of boron but which, on the other hand, are inert with regard to an aggressive environment is favored. On this account, boron nitride (BN) and in particular boron carbide (CB₄) prove to be very particularly advantageous as they respectively contain 39% and 75% of boron.

Thus, boron carbide (CB₄) is a material of great interest, in particular as component of electronics in a hostile environment, in place of silicon. Enriched with the ¹⁰B isotope of boron, it is also used as neutron absorbent in some types of nuclear reactors.

However, for the targeted applications, it is advisable for the material employed to have a particle size of less than 100 nm and preferably of between 80 nm and 50 nm.

In point of fact, boron carbide is as it happens a material having a very high hardness (Vickers hardness of greater than 30 MPa). The synthesis of boron carbide nanoparticles by a “top-down” method, in other words by reduction in size, for example by grinding, in order to obtain nanometric dimensions, thus proves to be unsuitable. One means of overcoming this difficulty is thus to directly access, according to a “bottom-up” approach, nanometric sizes during the process for the synthesis of the boron carbide.

Conventionally, CB₄ is obtained by pyrolysis/reduction, in a quartz furnace, of B₂O₃ in the presence of carbon and in a reducing atmosphere, for example of argon or of nitrogen. It is generally necessary to add a metal reducing agent, typically magnesium powder, in order to increase the reducing power of the reaction medium.

Unfortunately, this process does not prove to be completely satisfactory. In fact, it results in the formation of CB₄particles having a micrometric size, indeed even millimetric size.

Moreover, the CB₄ particles thus obtained have an insufficient degree of purity as the product obtained is contaminated by particles of magnesium boride and of graphite. These impurities are difficult to isolate from the boron carbide, being insoluble in the washing solvents. Neither is it possible to carry out an annealing under air or under molecular oxygen, insofar as such an annealing would then result in the transformation of the boron carbide into CO₂ and boron oxide (B₂O₃).

Furthermore, the boron carbide powder obtained is not completely devoid of uncombined boron and/or carbon, it being possible for the contents of these elements to be, for example, respectively of the order of 3 to 7% and of 2 to 3%. Finally, it is difficult to control the reproducibility with regard to the composition of the product obtained and in particular its stoichiometry.

Currently, different alternative routes for the synthesis of boron carbide relate to the use of polymeric precursors as carbon sources.

In particular, Fathi et al. [1] have developed a method for the synthesis of CB₄ nanoparticles from a polyvinyl alcohol (PVA) and boric acid. Boric acid (B(OH)₃) is known as being a crosslinking agent for polyvinyl alcohol. The addition of an aqueous boric acid solution to an aqueous polyvinyl alcohol solution thus results in the formation of a very rigid gel which may be dried. The dry form of this gel is subsequently pyrolyzed under air in a quartz furnace up to 800° C. in order to obtain boron carbide in the form of nanoparticles with a size of less than 100 nm. If need be, the crystallinity of the CB4 may be increased by an annealing under argon at 1300° C. without growth of the grains. This pyrolysis under air has the advantage of preventing the formation of carbon-based impurities impossible to separate from the CB₄. However, it also has the consequence of resulting predominantly in the formation of B₂O₃, and thus in an insufficient CB₄ yield, of less than 10%, as illustrated in the following example 1.

Kakiage et al. [2] describe, for their part, the formation of a boron carbide powder from the condensation product of boric acid and glycerol. The synthesis yield obtained is not specified. In addition, the particle size obtained, of the order of 1.1 μm, is not sufficient for the applications envisaged for the boron carbide, which are touched on above.

Consequently, the processes currently available do not make it possible to access, with a satisfactory yield, CB₄ particles simultaneously having a particle size at the nanometric scale, preferably of less than 100 nm, and a high purity.

It is specifically an object of the present invention to provide a novel route for the synthesis of CB₄ particles which makes it possible to satisfy all of these requirements.

More specifically, the present invention relates to a process for the preparation of boron carbide (CB₄) nanoparticles, characterized in that it comprises at least the stages consisting in:

(i) interacting boric acid (B(OH)₃), boron oxide B₂O₃ or a boric acid ester of B(OR)₃ type, with R, which are identical or different, representing C₁₋₄-alkyl groups, with 1 to 2 molar equivalents of at least one C₂to C₄ polyol, under conditions favorable to the formation of a boron alkoxide powder;

(ii) interacting, in an aqueous medium, the boron alkoxide powder obtained on conclusion of stage (i) with an effective amount of one or more completely hydrolyzed polyvinyl alcohols (PVAs), with a molar mass of between 10 000 and 80 000 g.mol⁻¹, under conditions favorable to the formation of a crosslinked PVA gel, and

(iii) carrying out an oxidizing pyrolysis of the crosslinked gel formed on conclusion of the preceding stage (ii), under conditions favorable to the formation of the CB₄ nanoparticles.

The process according to the invention proves to be advantageous on several accounts.

First of all, it makes possible access to CB₄ nanoparticles with a mean size of less than 100 nm, preferably of between 25 and 90 nm and in particular of between 50 and 80 nm. Thus, it is not necessary to grind the boron carbide particles, which are very hard, in order to grade them to a nanometric size.

Furthermore, as illustrated in example 1, the boron carbide reaction yield is significantly improved, in particular in comparison with the process provided by Fathi et al. [1]. In fact, the process of the invention makes it possible to access yields of boron carbide (calculated from the viewpoint of the initial weight of B(OH)₃ or of boric acid ester B(OR)₃ employed) of at least 40% by weight.

At the same time, the contents of impurities, in particular of carbon-based residues, are reduced, which is generally desired for the applications targeted for the boron carbide.

In addition, the process of the invention makes possible the synthesis of boron carbide with a good reproducibility of the results, which constitutes a major advantage for the industrial implementation of the process.

Finally, with respect to the conventional processes, the process according to the invention is advantageous with regard to the treatment temperatures and durations. In particular, it is not necessary to carry out an annealing in order to remove the impurities.

In fact, the inventors have found, contrary to all expectations, that the interaction of a boron alkoxide powder in accordance with the invention with a polyvinyl alcohol, according to stage (ii) of the invention, makes it possible to access a crosslinked PVA gel exhibiting a significantly improved homogeneity in comparison with that of a gel obtained by direct addition of boric acid to an aqueous PVA solution.

This is because the method of synthesis, for example described by Fathi et al. [1], carrying out the addition of boric acid directly to the aqueous PVA solution, brings about an immediate but heterogeneous gelling. In particular, regions rich in B(OH)₃ and regions rich in weakly crosslinked PVA are observed in the gel formed. It is the same during the use of boron alkoxides of low molecular weight, such as B(OMe)₃ or B(OEt)₃, these alkoxides hydrolyzing and condensing to give small clusters rich in boron.

Advantageously, without being committed by the theory, in the case of the method of synthesis according to the invention, the formation of the crosslinked PVA gel is significantly slowed down. The result of this is a homogeneous distribution of the boron in the gelled material.

In point of fact, the inventors have discovered that the homogeneity of the gel has a significant effect on the qualities of the material obtained on conclusion of the oxidizing pyrolysis. Thus, as illustrated in the following example 1, during an oxidizing pyrolysis carried out in a quartz furnace with a rise in temperature of 160° C. per hour and under flushing with 50 liters of air per hour, the heterogeneous gels as obtained by Fathi et al. [1] result in a low yield for synthesis of CB₄ (10% by weight, with respect to the B(OH)₃ charged).

On the other hand, in the case of the process according to the invention, this yield is advantageously significantly increased. What is more, the size of the particles remains less than 100 nm.

Again, advantageously, the formation of the boron carbide by pyrolysis according to the process of the invention does not require the introduction of an alkali metal or alkaline earth metal reducing agent, such as magnesium metal. In fact, in the synthesis routes described in the literature, employing sugars, starches or celluloses as carbon sources, the addition of such a reducing agent is necessary in order to prevent degradation of the carbon source to give CO₂ and H₂O, and to obtain boron carbide ([3]). However, such an addition has the side effect of generating a product contaminated by impurities, such as magnesium boride and graphite, which are difficult to isolate from the boron carbide.

The inventors have found that, even in the context of a pyrolysis under oxidizing conditions and in the absence of reducing agents, the PVA employed according to the process of the invention, by retaining its moisture, forms an effective barrier to the diffusion of the oxygen and to the oxidizing radicals within the reaction medium. It follows that, contrary to all expectations, the oxidizing pyrolysis carried out according to the invention makes it possible to access the boron carbide with a high yield. In addition, it advantageously makes it possible to overcome the ancillary formation of contaminants, such as magnesium boride particles.

Other characteristics, alternative forms and advantages of the process according to the invention will more clearly emerge on reading the description, examples and figures which will follow, given by way of illustration and without limitation of the invention.

In the continuation of the text, the expressions “between . . . and . . . ”, “of between . . . and . . . ”, “ranging from . . . to . . . ” and “varying from . . . to . . . ” are equivalent and are intended to mean that the limits are included, unless otherwise mentioned.

Unless otherwise indicated, the expression “comprising a(n)” should be understood as “comprising at least one”.

### Stage (i): Preparation of a Boron Alkoxide

As touched on above, a first stage of the process of the invention consists in obtaining a boron alkoxide powder.

The boron alkoxide powder under consideration according to the invention is more particularly obtained from:
boric acid (denoted H₃BO₄ or B(OH)₃), boron oxide B₂O₃ or a boric acid ester of B(OR)₃ type, with R, which are identical or different, representing C₁₋₄-alkyl groups, in particular methyl or ethyl, such as trimethyl borate or triethyl borate; and
one or more C₂ to C₄ polyols, in particular as described below.

The polyols are employed in a proportion of 1 to 2 molar equivalents, with respect to the boric acid, to the boron oxide or to the boric acid ester B(OR)₃. The boron alkoxide obtained on conclusion of stage (i) thus still exhibits at least one B—OH or B—OR bond which is reactive in stage (ii) with regard to the hydrolyzed polyvinyl alcohol.

Preferably, the boron alkoxide powder under consideration according to the invention is obtained from boric acid or one of its esters B(OR)₃, in particular from boric acid, trimethyl borate or triethyl borate.

Preferably, the polyols employed exhibit a molecular weight of between 62 and 106 g.mol⁻¹, in particular of less than or equal to 76 g.mol⁻¹.

According to a specific embodiment, the polyol is chosen from diols and triols.

In particular, the polyol may be chosen from ethylene glycol (ethane-1,2-diol), propylene glycol (propane-1,2-diol), diethylene glycol (2,2′-oxydiethanol), propane-1,3-diol, butane-2,3-diol, butane-1,2-diol, butane-1,2,4-triol, glycerol and their mixtures.

Preferably, it is chosen from ethylene glycol, propylene glycol, glycerol and their mixtures.

Of course, a person skilled in the art is in a position to adjust the experimental conditions for the formation of the pulverulent boron alkoxide material desired.

In particular, stage (i) may be carried out via the bringing together of boric acid or one of its esters B(OR)₃ or boron oxide B₂O₃ and of said polyol(s), followed by the heating of the reaction medium.

The heating may more particularly be carried out at a temperature of between 50° C. and 150° C., in particular at a temperature of approximately 120° C.

Preferably, the heating is carried out under an oxidizing atmosphere, in particular under air.

The dissolution of the reactants is faster or slower as a function of the nature of the polyol(s) employed.

The duration of the heating may be between 30 minutes and 2.5 hours, in particular be approximately 2 hours.

On conclusion of the heating, a boron alkoxide powder is obtained.

As specified above, this preliminary stage of transformation of the boric acid (or one of its esters of B(OR)₃ type or boron oxide B₂O₃) to give boron alkoxide in accordance with the process of the invention conditions the formation, in stage (ii) described in detail below, of a homogeneous crosslinked PVA gel, particularly advantageous for accessing, by oxidizing pyrolysis, the desired CB₄ nanoparticles.

### State (ii): Formation of the Crosslinked PVA Gel

The second stage of the process of the invention consists in interacting, in an aqueous medium, the boron alkoxide powder obtained in stage (i) with an effective amount of one or more polyvinyl alcohols under conditions favorable to the formation of a crosslinked PVA gel.

In the continuation of the text, the polyvinyl alcohol(s) employed according to the invention will be denoted more simply under the normal abbreviation “PVA(s)”.

Stage (ii) may more particularly be carried out by addition of the boron alkoxide powder prepared as described above to an aqueous PVA solution, followed by the heating of the reaction medium.

In particular, in the context of the process of the invention, the PVA is not brought together with boric acid.

The PVAs which are very particularly suitable for the invention have a molar mass adjusted in order to retain, in the aqueous reaction medium containing them, a degree of fluidity. Thus, it is desirable for the viscosity of this medium not to exceed 20 to 50 Pa.s⁻¹.

The viscosity may, for example, be measured using a device of Ford cup type.

Thus, the PVAs with a molar mass of less than 80 000 g.mol⁻¹, in particular of between 10 000 and 80 000 g.mol⁻¹, especially of between 20 000 and 80 000 g.mol⁻¹ and more particularly of between 50 000 and 80 000 g.mol⁻¹ are very particularly suitable. For example, the PVA employed may have a molar mass of 50 000 g.mol⁻¹.

The use of such polyvinyl alcohols makes it possible to obtain crosslinked PVA gels which may be handled under hot conditions.

Furthermore, as indicated above, the PVAs employed according to the invention are completely hydrolyzed.

Typically, a polyvinyl alcohol is obtained by alkaline hydrolysis of polyvinyl acetate. It is considered, within the meaning of the invention, that the polyvinyl alcohol resulting from the polyvinyl acetate is completely hydrolyzed when the degree of hydrolysis is greater than or equal to 98%.

For this reason, the polyvinyl alcohol employed according to the invention does not constitute a source of acetic acid, capable of resulting, during the oxidizing pyrolysis carried out in stage (iii), in the formation of boron oxide (B₂O₃) to the detriment of the desired boron carbide.

A person skilled in the art is in a position to adjust the experimental conditions of reaction of the boron alkoxide and PVA, for example in terms of amounts of reactants, temperature of the reaction medium and duration of the reaction, in order to obtain a crosslinked PVA gel.

The term “effective amount” of PVA is understood to mean, within the meaning of the invention, a sufficient amount of PVA to obtain the desired crosslinked gel, capable of resulting, under pyrolysis, in the CB₄ nanoparticles.

It is more particularly advantageous to employ, according to stage (ii) of the process of the invention, the boron alkoxide and the PVA in a PVA/boron alkoxide ratio by weight of between 0.5 and 1.5, in particular between 0.75 and 1.2. Preferably, the amount by weight of PVA is equivalent to the amount by weight of boron alkoxide.

Such a PVA/boron alkoxide ratio by weight makes it possible to promote the formation of the desired boron carbide while limiting the formation of boron oxide (B₂O₃) and while avoiding the generation of the difficult-to-remove graphite.

Typically, stage (ii) may be carried out by heating the reaction medium at a temperature of between 5 and 100° C., preferably between 60 and 90° C. and in particular of approximately 80° C.

The heating may be maintained for a duration of between 1 hour and 5 hours, in particular between 1 h 30 and 2 h 30 and more particularly for two hours.

Such a heating makes it possible to obtain a good homogeneity of the medium.

Preferably, the reaction medium may be kept stirred, prior to the heating and/or during the gelling, for example using a stirring system, in order to ensure a good homogeneity of the reaction medium, in particular a homogeneous dispersion of the boron in the reaction medium.

As illustrated in the following example 1, the crosslinked PVA gel formed on conclusion of stage (ii) according to the invention results from a slow and homogeneous gelling.

The crosslinked PVA gel according to the invention advantageously exhibits a good homogeneity in terms of distribution of the boron within the gel formed.

A gel, clear and transparent over the whole of the visible spectrum, is the evidence of a good homogeneity of the medium obtained. In particular, there are, within the gel obtained on conclusion of stage (ii), no microdomains rich in boron alkoxide and others rich in PVA.

The crosslinked PVA gel may, prior to the oxidizing pyrolysis (iii), be dried and reduced to a powder.

Stage (iii): Oxidizing Pyrolysis

According to stage (iii) of the process of the invention, the homogeneous crosslinked PVA gel is subjected to a treatment by oxidizing pyrolysis.

The term “oxidizing pyrolysis” is understood to mean, within the meaning of the invention, that the pyrolysis is carried out under an oxidizing atmosphere, for example under air, with the aim of promoting the removal of the carbon and of preventing the formation of carbon-based impurities.

Thus, the pyrolysis in stage (iii) may advantageously be carried out under flushing with air, for example with 50 l of air per hour.

The pyrolysis may be carried out in a conventional furnace, for example a quartz furnace.

The pyrolysis temperature may be between 500° C. and 1200° C., in particular between 600° C. and 1000° C. and more preferably of 800° C.

Preferably, the temperature is reached with a rise in temperature of 50° C. to 200° C. per hour, in particular of 160° C. per hour.

With such a rise in temperature for the oxidizing pyrolysis treatment, a loss of boron by entrainment with the trapped polyols might have been feared. Surprisingly, the inventors have found that, contrary to all expectations, the boron is indeed trapped in its PVA gangue, the pyrolysis treatment making it possible to result in the formation of the desired CB₄ nanoparticles.

The product may be maintained at the pyrolysis temperature for a period of time of at least 2 hours.

It is up to a person skilled in the art to adjust the conditions of the pyrolysis, in particular of the duration of pyrolysis, from the viewpoint of the furnace employed, in particular with respect to the geometry of the furnace used.

As touched on above, the formation of the boron carbide by pyrolysis according to the process of the invention does not require the introduction of an alkali metal or alkaline earth metal reducing agent, such as magnesium metal.

Advantageously, the pyrolysis carried out according to the invention thus makes it possible to overcome the ancillary formation of certain contaminants, for example of magnesium boride particles.

### Boron Carbide Particles Obtained According to the Invention

Advantageously, as illustrated in the following example 1, the oxidizing pyrolysis carried out according to the invention results in the formation of boron carbide with a significantly improved yield, in comparison with the pyrolysis carried out according to Fathi et al. [1].

The yield for the synthesis of boron carbide may, for example, be evaluated with respect to the initial weight of B(OH)₃, of B₂O₃ or of the boric acid ester B(OR)₃ charged.

In particular, the reaction yield for boron carbide according to the invention is advantageously greater than 20% by weight, in particular greater than or equal to 30% by weight and advantageously greater than or equal to 35% by weight.

The ancillary byproducts, boron oxide (B₂O₃), CO₂ and H₂O, may be easily removed from the reaction medium obtained on conclusion of the oxidizing pyrolysis. For example, simple washing with water makes it possible to remove the traces of boron oxide.

The boron oxide may then be recycled in stage (i) of the process of the invention or also be converted into boric acid, the latter being recycled in stage (i) of the process of the invention.

Furthermore, advantageously, the boron carbide obtained on conclusion of the process of the invention is of high purity. In particular, it comprises little in the way of, indeed even is completely devoid of, carbon-based residues.

The presence or absence of graphite may, for example, be confirmed by X-ray diffraction analysis. The formation of CB₄ and of ancillary products, such as boron oxide, may be confirmed by FTIR (Fourier transform infrared) analysis.

The mean size of the boron carbide particles obtained according to the invention is less than or equal to 100 nm, in particular strictly less than 100 nm, especially less than or equal to 90 nm, in particular between 25 and 80 nm and more particularly between 50 and 80 nm. The size may be evaluated by observation of the powders by scanning electron microscopy (SEM).

Furthermore, the nanoparticles obtained exhibit a low dispersion in size. In particular, 95% of the particles exhibit a size of less than or equal to 100 nm and preferably 80% of the particles exhibit a size of between 80 nm and 50 nm. The dispersion in size may be evaluated by analysis of the nanoparticles by SEM.

The boron carbide nanoparticles obtained on conclusion of the process of the invention exhibit an overall spherical shape.

According to a specific embodiment, the process of the invention may comprise a subsequent stage of thermal annealing of the boron carbide nanoparticles. This annealing stage makes it possible to increase the crystallinity of the boron carbide, without influencing the size of the nanoparticles.

This annealing may be carried out at a temperature of between 800° C. and 1600° C., in particular of approximately 1300° C., especially under an inert atmosphere. It may be carried out for a period of time ranging from 2 hours to 5 hours, in particular for approximately 3 hours.

### EXAMPLES

### Synthesis of Boron Carbide Nanoparticles

### Synthesis Protocol

5 g of B(OH)₃ (0.083 mol) are mixed with 7.75 g of ethylene glycol. The mixture obtained is heated under air at 120° C. for two hours, then crystallizes from return to ambient temperature.

The powder obtained, which is transparent and slightly yellow, is ground. 4 g of this powder are added to 100 g of a 4% aqueous solution of hydrolyzed PVA (Mowiol 4-98 MW 27000, Mowiol 6-98 MW 47000 or PVA Aldrich MW 77000-79000, 98% hydrolyzed).

The reaction medium is heated at 80° C. for 2 hours. Complete dissolution of the boron alkoxide is observed, followed by an increase in the viscosity with formation of a solid homogeneous gel which is transparent or slightly white.

The gel is dried and then ground. It is subsequently pyrolyzed at 800° C. in a porcelain boat in a quartz tubular furnace under air (50 liters of air per hour; rise of 160° C. per hour).

The gray powder obtained on conclusion of the oxidizing pyrolysis is washed with water, in order to remove the traces of B₂O₃, and then dried at 300° C. in an oven.

Similar syntheses were carried out by employing propylene glycol or glycerol in place of ethylene glycol and/or trimethyl borate (B(OMe)₃) or triethyl borate (B(OEt)₃) in place of boric acid.

### Results

### Characterization of the Boron Carbide Powders

The analysis by infrared absorption spectroscopy of the powders obtained under the abovementioned conditions confirms the formation of boron carbide with a peak, attributable to the C—B bond, at 1170 cm⁻¹.

The boron carbide powders may also be observed by scanning electron microscopy (SEM). The photographs obtained by SEM testify to a population of homogeneous spherical crystals, with a size of less than 90 nm.

### Synthesis Yield

The yield of boron carbide obtained is measured with respect to the initial weight of B(OH)₃ (or of boric acid ester) introduced at the start of the synthesis.

Under the conditions described above, using boric acid and, as polyol of low molecular weight, ethylene glycol, propylene glycol or glycerol, a yield of boron carbide of approximately 40% by weight is obtained on conclusion of the oxidizing pyrolysis.

In the same way, the use, as starting material, of B(OMe)₃ and of B(OEt)₃ instead of boric acid with 1 to 2 molar equivalents of a polyol of low molecular weight (ethylene glycol, propylene glycol or glycerol) makes it possible to access, on conclusion of the oxidizing pyrolysis, a synthesis yield of boron carbide of 35 to 40% by weight.

On the other hand, the synthesis of boron carbide by employing the protocol of Fathi et al. [1], with a hydrolyzed PVA of Mowiol 4-98 type, results, after washing the pyrolyzed gray powder with water, in a yield of boron carbide of 9 to 10% by weight, with respect to the boric acid charged.

A similar synthesis, according to the protocol of Fathi et al [1], with a grade of PVA sold by Aldrich, 98% hydrolyzed and with a molecular weight of 3000 g.mol⁻¹, still results in a synthesis yield of boron carbide of approximately 10% by weight.

### REFERENCES

[1] Fathi et al., Synthesis of boron carbide nano particles using polyvinyl alcohol and boric acid, Ceramics—Silikaty, 56(1), 32-35 (2012);

[2] Kakiage et al., Low-temperature synthesis of boron carbide powder from condensed boric acid-glycerin product, Materials Letters, 65 (2011), 1839-1841;

[3] Murray, Low temperature Synthesis of Boron Carbide Using a Polymer Precursor Powder Route, School of Metallurgy and Materials, University of Birmingham, Sept 2010-Sept 2011.

1. Process for the preparation of boron carbide nanoparticles, comprising at least the stages consisting in:
(i) interacting boric acid, boron oxide B₂O₃ or a boric acid ester of B(OR)₃ type, with R, which are identical or different, representing C₁₋₄-alkyl groups, with 1 to 2 molar equivalents of at least one C₂ to C₄ polyol, under conditions favorable to the formation of a boron alkoxide powder;
(ii) interacting, in an aqueous medium, the boron alkoxide powder obtained on conclusion of stage (i) with an effective amount of one or more completely hydrolyzed polyvinyl alcohols, with a molar mass of between 10 000 and 80 000 g.mol⁻¹, under conditions favorable to the formation of a crosslinked PVA gel, and
(iii) carrying out an oxidizing pyrolysis of the crosslinked gel formed on conclusion of the preceding stage (ii), under conditions favorable to the formation of the CB₄ nanoparticles.

2. Process according to claim 1, said CB₄ nanoparticles having a mean size of less than or equal to 100 nm.

3. Process according to claim 1, in which stage (i) is carried out starting from boric acid, trimethyl borate or triethyl borate.

4. Process according to claim 1, in which the polyol in stage (i) is chosen from ethylene glycol, propylene glycol, diethylene glycol, propane-1,3-diol, butane-2,3-diol, butane-1,2-diol, butane-1,2,4-triol, glycerol and their mixtures.

5. Process according to claim 1, in which the polyol in stage (i) is chosen from ethylene glycol, propylene glycol, glycerol and their mixtures.

6. Process according to claim 1, in which stage (i) is carried out via the bringing together of boric acid or one of its esters B(OR)₃ or boron oxide B₂O₃ and of said polyol(s), followed by the heating of the reaction medium.

7. Process according to claim 6, in which the heating is carried out at a temperature of between 50° C. and 150° C.

8. Process according to claim 7, in which the heating is carried out under an oxidizing atmosphere.

9. Process according to claim 1, in which stage (ii) is carried out by addition of the boron alkoxide powder to an aqueous solution of polyvinyl alcohol(s), followed by the heating of the reaction medium.

10. Process according to claim 9, in which the heating is carried out at a temperature of between 5° C. and 100° C.

11. Process according to claim 9, in which the duration of the heating is between 1 hour and 5 hours.

12. Process according to claim 1, in which the pyrolysis in stage (iii) is carried out by heating at a temperature of between 500° C. and 1200° C.

13. Process according to claim 1, in which the pyrolysis in stage (iii) is carried out under flushing with air.
